(19) United States
(12) Patent Application Publication
(10) Pub. No.: US 2026/0158451 A1
(43) Pub. Date: Jun. 11, 2026

(54) POROUS CAGE MEMBRANES

(71) Applicant: Khalifa University of Science and Technology, Abu Dhabi (AE)

(72) Inventors: Emad ALHSEINAT, Abu Dhabi (AE); Jisha Kuttiani ALI, Abu Dhabi (AE)

(21) Appl. No.: 19/412,594

(22) Filed: Dec. 8, 2025

Related U.S. Application Data
(60) Provisional application No. 63/730,789, filed on Dec. 11, 2024.

(51) Int. Cl. B01D 69/02; B01D 65/02; B01D 67/00; B01D 69/10; B01D 71/58; C02F 1/44; C02F 101/20

(52) U.S. Cl. CPC B01D 69/02; B01D 65/02; B01D 67/0006; B01D 69/107; B01D 71/58; C02F 1/44; B01D 2321/168; B01D 2323/12; B01D 2323/219; B01D 2325/02832; B01D 2325/04; B01D 2325/34; C02F 2101/20; C02F 2303/16

(57) ABSTRACT

A process for preparing a Porous Cage Membrane, the process comprising: forming a Porous Organic Cage polymer by reacting 1,3,5-triformylbenzene with tris(4-aminophenyl)amine in a solvent comprising methanol; and depositing the Porous Organic Cage polymer onto a porous support to form the Porous Cage Membrane.

### CROSS-REFERENCE TO RELATED APPLICATIONS

This application claims the benefit of and priority to U.S. provisional application 63/730,789, titled METHOD AND PROCESS METAL REMOVAL AND RECOVERY BASED ON SOLVENT RESPONSIVE POROUS ORGANIC CAGE MEMBRANE”, filed Dec. 11, 2024, the contents of which are incorporated by reference herein.

### TECHNICAL FIELD

The subject matter disclosed herein relates to Porous Cage Membranes for filtering and separation.

### BACKGROUND

Membrane separation is by far the most widely used physical barrier separation technique for treating water, because it is both highly effective at removing contaminants while also being more energy efficient and cost effective than competing physical barrier separation techniques. At present, the material for most membranes is selected from conventional amorphous polymers such as polyvinylidene fluoride, polyimide, polysulfone, polyether sulfone, chitosan, and poly(amide-imide)-based crosslinked polymers and other similar material. However, due to the unordered pore channels (meaning there is limited to no network connectivity or long-range order), low porosity, and lack of uniform pore size, these membranes present a trade-off between selectivity (the ability of a membrane or filter media to separate the contaminants and other targeted molecules from the influent feed water) and permeability (the ease with which this influent can pass through the membrane).

In recent years, porous materials such as metal-organic frameworks (MOFs) and covalent-organic frameworks (COFs) have gained attention for their potential for a wide variety of molecular separation applications, including water treatment and purification. However, the practical use of these membranes in industry is restricted because they have minimal solubility in common solvents, limiting the processability of these framework materials and leaving them especially prone to collapse after the removal of the solvent molecules. Yang et al., Chemical Reviews (2023). More fundamentally, despite initial claims that COF materials possessed a long-range porous structure allowing for efficient, directional, and size selective separation of contaminants, more recent research indicates that in fact COFs are much closer to conventional adsorbents, with their limited long range order, tortuous and noncontinuous pathways, and relying primarily on adsorption affinities to drive separation rather than size selection. Fenton et al., Journal of ACS (2021).

Accordingly, there is a continuing need for membranes with high separation efficiency and high permeability but unlike COFs are sufficiently robust to be scalable to industrial quantities and that have well-defined three-dimensional long-range pore structures capable of separating contaminants by size-sieving rather than selective adsorption.

### SUMMARY

According to one aspect a process for preparing a Porous Cage Membrane by forming a Porous Organic Cage polymer by reacting 1,3,5-triformylbenzene with tris(4-aminophenyl)amine in a solvent comprising methanol; and depositing the Porous Organic Cage polymer onto a porous support comprising polytetrafluoroethylene to form the Porous Cage Membrane.

According to another aspect, a membrane, comprising: a porous support comprising polytetrafluoroethylene (PTFE); and a Porous Organic Cage polymer layer on the porous support, wherein the Porous Organic Cage polymer layer comprises imine linkages formed from condensation of 1,3,5-triformylbenzene and tris(4-aminophenyl)amine.

According to an additional aspect a method for separating heavy metals from an aqueous solution comprising: (a) passing the aqueous solution through a membrane to capture heavy metal retentate on the membrane and form a treated aqueous solution; (b) regenerating the membrane by flushing a volatile organic solvent through the membrane to release the heavy metal retentate from the membrane to form a metal-rich volatile organic solvent; wherein the membrane comprises: a porous support comprising polytetrafluoroethylene (PTFE); and a Porous Organic Cage polymer layer on the porous support, wherein the Porous Organic Cage polymer layer comprises imine linkages formed from condensation of 1,3,5-triformylbenzene and tris(4-aminophenyl)amine.

### BRIEF DESCRIPTION OF THE DRAWINGS

FIG. 1(a) shows FT-IR spectra of for both PCM and COF membrane confirming the formation of imine bonds.

FIG. 1(b) shows FT-IR spectra of a PCM membrane and amine and aldehyde monomer confirming the disappearance of NH signals in the PCM membrane.

FIG. 2(a) shows powder X-ray Diffraction (“PXRD”) patterns of the monomers 1,3,5-triformylbenzene and tris(4formylphenyl) amine.

FIG. 2(b) shows the PXRD patterns of PCM and COF made by the reaction of 1,3,5-triformylbenzene and tris(4formylphenyl) amine monomers.

FIG. 3(a) shows N₂ adsorption and desorption curves for PCM and COF materials.

FIG. 3(b) shows the pore size distribution curve for PCM materials.

FIG. 3(c) shows the pore size distribution curve for COF materials.

FIG. 3(d) shows the TGA analysis of PCM and COF materials.

FIG. 4(a) shows (a) 13C-CP MAS NMR spectra of PCM and COF.

FIG. 4(b) shows identification of each NMR spectra shift with the bonds in tris(4-aminophenyl)amine.

FIG. 5 shows the MALDI-TOF-MS spectra of COF.

FIG. 6(a) shows the MALDI-TOF-MS spectra of PCM.

FIG. 6(b) illustrates the reaction scheme for PCM.

FIG. 7 shows structural evaluation of PCM and COF based on MALDI-TOF-MS spectra.

FIG. 8 shows the MALDI-TOF-MS spectra of the COF2 sample.

FIG. 9 shows the MALDI-TOF-MS spectra of the COF3 sample.

FIG. 10(a) shows a Scanning Electron Microscope (“SIEM”) image of PCM material and the corresponding hypothesized 3D molecular structure.

FIG. 10(b) shows a SEM image of the PCM material of FIG. 10(a) at a higher magnification.

FIG. 10(c) shows a Scanning Electron Microscope (“SEM”) image of COF material and the corresponding hypothesized 3D molecular structure.

FIG. 10(d) shows a SEM image of the COF material of FIG. 10(c) at a higher magnification.

FIG. 10(e) shows a proposed molecular structure for a Porous Organic Cage.

FIG. 10(f) shows a proposed molecular structure for a Porous Organic Cage.

FIG. 11(a1) shows a SEM image of the COF2 material.

FIG. 11(a2) shows a SEM image of the COF2 material.

FIG. 11(b1) shows a SEI image of the COF3 material.

FIG. 11(b2) shows a SEM image of the COF3 material.

FIG. 12(a1) shows a SEM image of PCM material on a PTFE support.

FIG. 12(a2) shows a cross-sectional SEM image of the PCM material in FIG. 12(a1).

FIG. 12(b1) shows a SEM image of the PCM2 material on a PTFE support.

FIG. 12(b2) shows a cross-sectional SEM image of the PCM2 material in FIG. 12(b1).

FIG. 12(c1) shows a SEM image of the PCM3 material on a PTFE support.

FIG. 12(c2) shows a cross-sectional SEM image of the PCM3 material in FIG. 12(c1).

FIG. 13 shows a custom-designed glass diffusion cell used in the present experiments.

FIG. 14(a) is a Graph showing the results of tests evaluating the performance of the PCM material at the removal of Rhodamine B (“Rh B”) dye.

FIG. 14(b) shows the UV-Vis absorption spectra of rhodamine B dye permeate in various water:methanol solvent mixtures.

FIG. 14(c) presents digital photographs of the Rh B permeate from FIG. 14(b).

FIG. 15(a) shows the results of tests utilizing the glass diffusion cell of FIG. 14 to evaluate the performance of the PCM material in blocking the transport of Ni²⁺.

FIG. 15(b) shows the results of the same test as FIG. 15(a) except for Zn²⁺.

FIG. 15(c) shows the flux of Ni²⁺ and Zn²⁺ in the test of FIGS. 15(a) and 15(b).

FIG. 16(a) shows the results of tests utilizing the glass diffusion cell of FIG. 13 to evaluate the performance of the PCM, PCM2, and PCM3 material in blocking the transport of heavy metals, Ni²⁺.

FIG. 16(b) shows the results of tests utilizing the glass diffusion cell of FIG. 13 to evaluate the performance of the PCM, PCM2, and PCM3 material in blocking the transport of heavy metals, Zn²⁺.

FIG. 17 shows the adsorption affinity/capacity for Ni²⁺ and Zn²⁺ in PCM material.

FIG. 18 shows the FT-IR spectra of the PCM material from the tests of FIGS. 16(a) and (b) after four days of operation.

FIG. 19(a) shows energy-dispersive X-ray (“EDX”) spectroscopy mapping from the tests of FIG. 16(a) after four days of operation.

FIG. 19(b) shows energy-dispersive X-ray (“EDX”) spectroscopy mapping from the tests of FIG. 16(b) after four days of operation.

FIG. 20 is a graph of the amount of Ni²⁺ and Zn²⁺ released from the PCM material in a heavy metal extraction experiment.

FIG. 21 is a graph of the amount of Ni²⁺ and Zn²⁺ retained from the PCM material in a heavy metal extraction experiment.

FIG. 22(a) shows a PXRD pattern of the PCM materials solvated in methanol.

FIG. 22(b) is a figure of the surface charge of the same material.

FIG. 23 is a graph showing a calibration curve for Rh B, plotting absorbance against concentration in mg/L.

FIG. 24 is a schematic illustrating the transport of Rhodamine B dye in water and methanol.

FIG. 25(a) is an Atomic Force Spectroscopy scan of the PCM membrane.

FIG. 25(b) is a microphotograph of a drop of methanol and water, illustrating the relative surface wettability.

FIG. 26(a) is a graph of the recycling performance of the PCM membrane for Rhodamine B dye removal in water and methanol.

FIG. 26(b) is a graph of the long-term stability and recycling performance of the PCM membrane for Ni²⁺ and Zn²⁺ in water and methanol.

FIG. 27 is proposed scheme for an apparatus for separating heavy metals from a heavy metal-contaminated aqueous solution by a Porous Cage Membrane and regenerating the PCM by releasing the heavy metals trapped on the PCM by flushing with a volatile organic solvent.

### DETAILED DESCRIPTION

The embodiments of the present disclosure introduce a separation membrane architecture, in which a Porous Organic Cage (“POC”) layer is deposited on a polytetrafluoroethylene (“PTFE”) substrate to form a Porous Cage Membrane (“PCM”), the POC layer providing a selective barrier that blocks contaminants. Porous Organic Cages are discrete molecules with intrinsic cages linked by weak, non-covalent interactions between molecules. POCs have extended, porous networks allowing for size-sieving of target contaminants and selective molecular transport. The “windows” into the internal cavity in each cage increase the water permeance of the membrane by creating well-defined, long range, and directional transport channels. Thus, unlike existing amorphous polymer membranes, POCs and PCMs offer both high contaminant rejection, and good water permeability. Indeed, not only do they offer these high levels of contaminant rejection, but in response to different solvents they exhibit a reversible change in their pore structure, allowing for tunable size-sieving of contaminants and giving heretofore unavailable control of the selectivity of the size-sieving, creating a membrane-based parallel to the use of solvent gradients in chromatography. He et al., Nature Materials (2022).

Additionally, the PCMs built with these POCs are easier to fabricate and more robust compared to other polymeric membranes and porous materials, due to their high solubilities in conventional solvents and excellent thermal and chemical stability.

The preparation of these materials, and their characterization along with how they are used to separate target heavy metal ions will now be discussed in detail.

### Porous Organic Cages and Porous Cage Membranes

Conventionally, Porous Organic Cages (“POC”) are typically formed by imine condensation of aldehyde and amine monomers in a solvent, preferably the solvent is dimethyl sulfoxide or N,N-dimethylformamide. In these conventional processes, the resulting POC is then transferred or coated onto a support material such as polyacrylonitrile that may then be used for filtration, separation and other end use applications.

By contrast, the present disclosure is based on the discovery of a novel PCM formed by selecting a certain combination of monomers and solvents not previously used for POC formation, which include: (a) the aldehyde monomer, 1,3,5-triformyl benzene (“TFB”); (b) the amine monomer, Tris(4-aminophenyl)amine (“TAPA”); (c) methanol; and (d) a porous polytetrafluoroethylene (“PTFE”) support. The reaction between TFB and TAPA occurs in the solution phase and so the methanol serves as both the solvent to dissolve the monomers and also a medium for the reaction and in situ formation of POC polymer on the PTFE substrate.

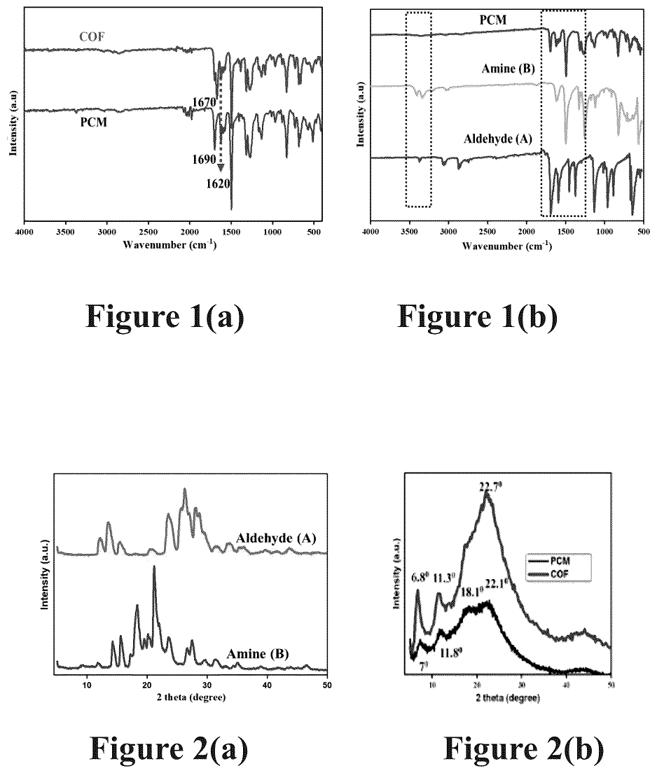

In this embodiment, the TFB monomer is dissolved in a solvent comprising methanol to form a TFB monomer solution and the TAPA monomer is dissolved in methanol to form a TAPA monomer solution. The two solutions are combined and mixed in a vessel containing a support comprising PTFE to initiate the imine condensation reaction in which the monomers are changed both chemically and physically. Chemically, the imine reaction (FIG. 1) not only changes the chemical identity of the monomers by breaking the amino N—H bonds and creating new imine C═N bonds but due to its own energetically-favored self-assembly creates the morphologically novel Porous Organic Cage structure shown in FIG. 1 that is unique to the present embodiment (this structure is confirmed by PXRD scans in the examples, below). Thus, the present embodiment takes advantage of the fact that the selected TFB and TAPA monomers both possess a specific C3-symmetric geometry. This unique geometry, in combination with the precise 4+4 reaction stoichiometry (4 molecules of TFB to 4 molecules of TAPA), dictates the self-assembly of these linkers into the highly organized Porous Organic Cage polymer.

As mentioned above, this reaction to form the POC polymer occurs in the solution phase and methanol has been specifically selected as the solvent because the Porous Organic Cage polymer has only limited solubility in methanol. Additionally, without being limited by theory, it is believed that methanol promotes the formation of POC polymer because unlike the other solvents mentioned above, such as dimethyl sulfoxide or N,N-dimethylformamide, methanol influences the self-assembly and polymerization process, providing a “template” to promote the formation of the open POC network to facilitate the formation of a flexible, responsive membrane rather than rigid, covalently-bonded network seen in conventional COFs and many POCs as well.

Thus, as the imine reaction proceeds and more POC polymer is produced as described above, the insoluble POC polymer begins to precipitate out of the methanol and onto the surface and into the pores of the porous PTFE substrate to create a selective flexible, responsive, size-sieving layer of the Porous Organic Cage polymer membrane, which can now effectively be used for filtration and separation.

The specific process for preparing PCMs according to the present embodiment, as follows. First, TFB aldehyde monomer and TAPA amine monomer are reacted in a solvent comprising methanol (preferably the solvent is methanol) to form a Porous Organic Cage polymer and the Porous Organic Cage polymer is deposited on a support comprising polytetrafluoroethylene (PTFE) to form the Porous Cage Membrane (preferably the support is PTFE). Optionally, the PTFE-containing support may be subjected to an O₂ plasma activation treatment to improve surface wettability and enhance adhesion of the polymer layer. Preferably, the TFB aldehyde and T APA amino monomers are reacted by mixing a first solution of TFB monomer dissolved in a first portion of solvent comprising methanol with a second solution of TAPA monomer dissolved in a second portion of solvent comprising methanol to form a Porous Organic Cage. Optionally, if the support has been activated by the O₂ plasma treatment, the support may be placed in the second solution and allowed to equilibrate for 10-15 minutes to promote initial adsorption of TAPA onto the activated PTFE-containing surface of the support, then the first solution may be added to and mixed with the second solution containing the support, being careful to add the first solution slowly to avoid disrupting the interface, allowing the imine condensation reaction to occur directly on and within the PTFE substrate.

The first solution contains about 1 mM to about 100 mM of TFB aldehyde monomer, while second solution contains about 1 mM to about 100 mM of the TAPA amino monomer. The TFB and TAPA solutions are preferably mixed in a stoichiometric ratio of TFB:TAPA of about 2:1 to about 5:2. The imine reaction and subsequent formation of the PCM is carried out over a broad temperature range of between about 20° C. to about 30° C. for a period of from about 48 to 120 hours. This allows time for the imine reaction to go to completion to produce POC polymer and for the polymer to deposit on the substrate forming a size-selective porous organic polymer barrier layer having a thickness of 145 microns to 192 microns. The resulting membrane-coated substrate is then typically washed (e.g., with fresh methanol) to remove any unreacted monomers and byproducts.

As discussed above, a highly advantageous feature of this membrane is its “tunability,” which refers to the ability to deliberately engineer and dynamically control its separation properties. This is most evident in the membrane's solvent-responsive behavior, where its porosity is not static but can be actively controlled. This tunability allows the membrane to be reversibly switched between a first, “open” porous state and a second, “closed” or constricted state, simply by changing the solvent environment. This mechanism provides on-demand control over the membrane's size-sieving characteristics. Without being limited by theory, it is believed that this solvent-responsive or “size switching” behavior results from the POC molecules being held together by hydrogen bonds and Van der Waals forces rather than the covalent forces as in this case with COFs.

When the membrane exists in methanol it is an “open” state, a less densely packed crystalline phase, in which the size of the Porous Organic Cage (“POC”) molecules is expanded and additionally there are strong host-guest interactions between the Porous Organic Cage and methanol, causing methanol molecules to lodge within the cage structure, locking the cage structure into place and preventing the obstructive undulation in water. In this “open” state, there is created an extensive network of long-range channels between the molecules—not merely the interstices in the POCs themselves. This expansion maximizes the pore structure and consequently the bulk porosity and effective pore diameter of the pore apertures, increasing the permeability of the membrane (the rate at which the solution/treated water flows) and decreasing the selectivity of the separation (i.e., allowing larger solutes to pass).

Conversely, the “closed” or constricted state is triggered by exposing the membrane to water, which induces a rapid phase transition to a more densely packed crystalline phase, causing the framework to contract and the pore apertures to shrink. In this state, the membrane is more selective, rejecting molecules that were able to pass through in the “open” state, and thus, the molecular weight cut-off is much lower. For additional description of these effects see especially the discussion below concerning the experiments illustrated in FIGS. 21-26.

The tunability is not limited to just two states. Instead, the membrane's pore apertures can be precisely controlled along a continuum. This is achieved by modulating the solvent environment using mixtures of solvents, such as varying the water/methanol ratio. By varying this ratio, the solvent-responsive crystalline membrane can be switched between different phases, each possessing a different selectivity. This effectively allows the membrane's molecular weight cut-off to be “dialed in” to a specific size.

Thus, the Porous Cage Membranes of the present embodiment exhibit solvent-responsive properties that enable a complete capture-and-recovery cycle for heavy metal ions from aqueous solutions. In operation, a method of removing heavy metal ions from an aqueous solution comprises contacting the aqueous solution with the membrane to retain metal ions within the Porous Organic Cage structure and subsequently recovering the retained metal ions by contacting the membrane with methanol.

When the membrane is in contact with an aqueous solution containing heavy metal ions such as nickel (Ni²⁺) or zinc (Zn²⁺), the Porous Organic Cage polymer contracts to a smaller pore size, typically about 7.4 Å, functioning as a size sieve against heavy metals like Ni²⁺ and Zn²⁺. The diameters of Ni²⁺ (approximately 8.08 Å) and Zn²⁺ (approximately 8.6 Å) exceed this contracted pore size, preventing permeation through the membrane. Additionally, the negative surface charge of the membrane at natural pH in water provides electrostatic interaction with the cationic metal ions, further restricting their movement. As a result, the metal ions are physically entrapped within the contracted cage structures rather than chemically adsorbed on the membrane surface.

To recover the captured metal ions, the ion-loaded membrane is contacted with methanol. The methanol causes the Porous Organic Cage polymer to expand to a larger pore size, typically about 12.6 Å. The solvated diameters of Ni²⁺ and Zn²⁺ ions in methanol (approximately 10 Å) are smaller than this expanded pore size, allowing the metal ions to be released from the cage structures into the methanol solution. This process is illustrated and discussed in detail in the Examples.

An embodiment of a process for applying this solvent responsive behavior to separating heavy metals from a heavy metal-contaminated aqueous solution is shown in FIG. 28. This process includes a feed tank 5 for the heavy metal-contaminated aqueous solution, a solvent tank 25 for a volatile organic solvent such as methanol, and a membrane unit 20 containing a Porous Cage Membrane (not shown). In operation, the heavy metal-contaminated aqueous solution 10 is pumped from the feed tank to the membrane unit 20 where it passes through the Porous Cage Membrane, which separates the heavy metal ions out of the aqueous solution to form a treated aqueous solution, leaving a heavy metal retentate on the PCM. The treated aqueous solution 45 is sent to the product storage tank 40 from which it may be sent for further purification and use elsewhere as purified water.

After a predetermined volume of the aqueous solution has been processed or when the PCM approaches saturation with the heavy metal retentate, the PCM is regenerated by flushing with a volatile organic solvent 15 supplied to release the accumulated retentate from the membrane to form a metal-rich volatile organic solvent stream 50 which collects in an organic solvent product tank. The metal-rich volatile solvent stream 50 is then separated in a stripping column 30 into a recovered heavy-metal-rich methanol bottoms stream 55 and a purified organic solvent overhead 60 which is collected in the solvent tank 25 and can then be recycled back to the membrane unit 20 for regeneration of the PCM therein.

The stripping column operates at pressures and temperatures sufficient to vaporize the volatile organic solvent while retaining the heavy metals in the liquid phase, typically 50-100° C. Heat may be supplied via steam, electrical heating, or heat exchange with process streams. The stripping column may be operated at sub-atmospheric pressures to accelerate vaporization. Most important is the choice of the volatile organic solvent. The volatile organic solvent should be sufficiently volatile so that it can be vaporized without excessive heat supply to the stripping column, while at the same time the solvated pores of the volatile organic solvent should be sufficiently large to allow the heavy metal ions to be released into the volatile organic solvent. Methanol is the preferred volatile organic solvent.

The heavy-metal-rich methanol bottoms stream 55 can then be further processed for metal recovery or disposal. Following regeneration by the volatile organic solvent, the PCM can be returned to service for additional cycles of metal ion capture from aqueous solutions. An optional volatile organic solvent extraction step may be used prior to returning the membrane to service if excessive organic solvent remains within the membrane.

### Examples

The embodiment will now be described in more detail with respect to the following non-limiting examples.

In addition to the specific descriptions below, the synthesis, characterization and structural outcomes for shape-persistent Porous Organic Cages have been documented in detail in Cooper et al., J. An. Chem. Soc. 2014, 136, 7583-7586 and its accompanying Supporting Information, all of which are hereby incorporated by reference.

### Materials and Equipment

The monomers 1,3,5-triformyl benzene and tris(4-aminophenyl)amine, the PTFE substrate, and other chemicals discussed in the experiments below were obtained from the Sigma-Aldrich Company and were used as received.

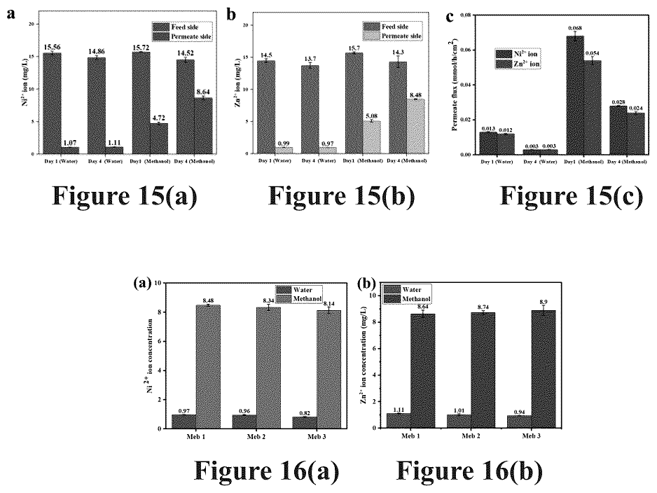

Heavy metal ion permeation test. Measurements were performed using a diffusion cell apparatus with an effective membrane area of 0.758 cm² (FIG. 14). For aqueous transport studies, 15 mL of an aqueous solution containing 25 mg/L Ni²⁺ (from Ni(NO₃)₂·6H₂O, 87% purity, Sigma-Aldrich) or Zn²⁺ (from Zn(NO₃)₂·6H₂O, 99% purity, Sigma-Aldrich) was added to the feed side, and 15 mL of water was added to the permeate side. For methanol transport studies, 15 mL of a methanolic solution containing 25 mg/L of Ni²⁺ (from Ni(NO₃)₂·6H₂O, 87% purity, Sigma-Aldrich) or Zn²⁺ (from Zn(NO₃)₂·6H₂O, 99% purity, Sigma-Aldrich) was added to the feed side, and 15 mL of methanol was added to the permeate side. In both cases, the feed and permeate sides were magnetically stirred to minimize concentration polarization effects. After a permeation time of 1 or 4 days (see FIGS. 15(a), (b), and (c) at room temperature, the cation concentrations on both the feed and permeate sides were measured using a DR 6000 UV-Vis spectrophotometer (Hach Instruments, United States) with Hach LCK 337 reagent kit for Ni²⁺ and LCK 360 reagent kit for Zn²⁺. The permeation rate (Ji, mmol h⁻¹ m⁻²) of cations was calculated using Equation (1):

$$Ji = ( ( C \times V ) ) / ( M \times A \times Δ t ) \qquad ( 1 )$$

Where C (g/mL) is the cation concentration on the permeated side, V (mL) is the effective volume of the solution in the permeated side, M (g mol-1) is the relative molecular mass of the cation, A (cm²) is the effective permeated area, and Δt (h) is the permeation time.

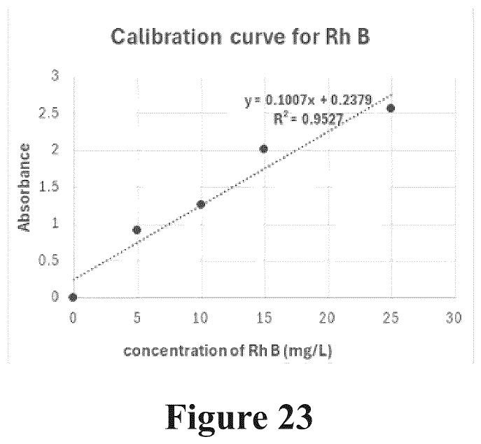

Dye Permeation Test. The removal performance of the PCM membrane for Rhodamine B dye (Rh B, 25 mg/L) was assessed by vacuum filtration at a pressure of 85 kPa using a membrane having an area of 9.61 cm². The dye concentration before and after filtration was measured at 550 nm using a DR6000 benchtop UV-Vis spectrophotometer (Hach, USA) operating over a wavelength range of 190-1100 nm with external calibration. For recycling studies, 10 mL of aqueous Rh B solution (25 mg/L) was filtered through the PCM membrane (area 9.61 cm²) using the vacuum filtration unit. Following complete filtration of the dye solution, 10 mL of methanol was filtered through the same membrane to remove Rh B retained on the membrane surface. This process was repeated for 5 consecutive cycles, where one cycle consisted of: (1) filtration of the aqueous dye feed solution through the PCM membrane, followed by (2) filtration of pure methanol to extract the dye from the membrane surface into the permeate. The filtrate from each step was analyzed using the DR6000 UV-Vis spectrophotometer over a wavelength range of 190-1100 nm with external calibration. The Calibration Curve is shown in FIG. 23.

The removal performance (R) of the membranes was calculated using Equation (2) from the initial concentration (Cᵢ) and permeate concentration (Cₚ) values:

$$R ( \% ) = [ 1 - Cp / Ci ] \times 100 \qquad ( 2 )$$

Permeate flux (J) was calculated using Equation (3), where V is the volume of permeated solution, Δt is the filtration time, and A is the membrane area:

$$J = V / ( A \times Δ t ) \qquad ( 3 )$$

The dye removal from the PCM membrane surface (Rₘₑₜₕₐₙₒₗ) using methanol during recycling studies was calculated using Equation (4):

$${R}_{methanol} ( \% ) = [ Cp / Ci ] \times 100 \qquad ( 4 )$$

Heavy metal ion recovery test. Metal recovery performance was evaluated using PCM membranes in methanol. Following the ion permeation test in water, the dried PCM membrane (area 0.785 cm²) was transferred to a beaker containing 15 mL of methanol and placed on a shaker at 100 rpm at room temperature for 2 days. After 2 days, the membrane was removed and the methanol solution was evaporated at 30° C. The residue was then redissolved in 15 mL of deionized water. The aqueous samples were analyzed using a DR 6000 UV-Vis spectrophotometer with Hach LCK 337 reagent kit for Ni²⁺ and LCK 360 reagent kit for Zn²⁺. The percentage of heavy metal retained inside the PCM membrane, C_{PCM} (%), and the percentage of heavy metal recovered, C_{Recovery} (%), were calculated using equations (5) and (6):

$${C}_{PCM} ( \% ) = ( ( {C}_{i} - ( {C}_{f} + {C}_{p} ) ) / {C}_{i} \times 100 \qquad ( 5 )$$

$${C}_{Recovery} ( \% ) = {C}_{r} / {C}_{PCM} \times 100 \qquad ( 6 )$$

where C_{PCM} (%) is the percentage of heavy metal retained inside the PCM membrane, Cᵢ is the initial concentration of heavy metals, C_{f} is the concentration of heavy metals in the feed side after 2 days, Cₚ is the concentration of heavy metals in the permeate side after 2 days, C_{Recovery} (%) is the percentage of heavy metal recovered after 2 days, C_{PCM} (mg/L) is the concentration of heavy metals inside the membrane after 2 days, and Cᵣ is the concentration of heavy metals in the aqueous solution after the recovery test.

Long-term stability and recyclability tests. These were carried out using a diffusion cell apparatus using a diffusion cell apparatus with a membrane area of 0.785 cm². For heavy metal ion transport testing, 15 mL of an aqueous solution containing 25 mg/L of Ni²⁺ (from Ni(NO₃)₂·6H₂O, 87% purity, Sigma-Aldrich) ions was added to the feed side, and 15 mL of deionized water was added to the permeate side. Both feed and permeate sides were magnetically stirred at room temperature to minimize concentration polarization effects. After 2 days, the aqueous solutions on both the feed and permeate sides were completely replaced with 15 mL of methanol, and the experiment continued for an additional 2 days under the same stirring conditions. After the methanol phase, samples were collected from the permeate side and analyzed by inductively coupled plasma optical emission spectroscopy (ICP-OES, Thermo Scientific iCAP 7600) to determine the Ni²⁺ ion concentration. One complete cycle consisted of 4 days total: 2 days with water as the solvent followed by 2 days with methanol as the solvent. This procedure was repeated for two additional cycles using the same membrane, for a total of three cycles. The same experimental procedure was performed for Zn²⁺ ions.

Fourier transform infrared Spectroscopy. (FTIR) Spectra were collected using Bruker Vertex 80v ATR-FTIR from 4000-400 cm⁻¹. 16 scans were collected at a resolution of 4 cm⁻¹ in transmission mode.

Powder X-ray diffraction. X-ray data from PCM and COF powder samples were collected in transmission mode on a Philips 18 PW3040/60 X-ray diffractometer using Ni-filtered Cu-Kα radiation (λ=0.1542 nm) from 0 to 60° over approximately 13 minutes Surface area and pore volume. The surface area and pore volume of PCM and COF samples was carried using a Micromeritics ASAP 2020 surface area and porosimetry analyzer (Micromeritics Corporation, USA) at 77 K in a liquid nitrogen environment, by the Barett, Joyner and Halenda (BJH), and the Brunauer, Emmett and Teller methods for surface area and pore volume, respectively.

Thermogravimetric analysis (TGA). TGA scans were done with a Netzsch 449 F3 Jupiter (Netzsch GmbH & KGaA, Germany) simultaneous thermal analyzer coupled with a Netzsch MSQMS 403D Aeolos mass spectrometer and applied for at a heating rate of 10° C. per min within a temperature range of 20-800° C. under N₂ atmosphere.

Energy Dispersive X-Ray (EDX) Spectroscopy. EDX mapping was recorded for PCM samples using a ThermoFisher Scientific Quanta 3D FIB instrument equipped with an EDS detector at 30 keV of acceleration voltage. All samples were mounted on SEM sample stubs using a double-side adhesive copper tape and coated with a gold layer (10 nm) in a sputtering machine in preparation for analysis. The average thickness of membranes was calculated from different areas of cross-sectional images.

Surface Microscopy. The morphology of powder samples, surface, and cross-section of PCM membrane samples was imaged on an environmental scanning electron microscope (ESEM), using a ThermoFisher Scientific Quanta 250 ESEM in high vacuum mode, at the appropriate acceleration voltages and magnifications. Sample preparation was as described above for EDX.

Solid state NMR. ¹³C Nuclear Magnetic Resonance Spectra of powder PCM and COF were obtained using an NMR Spectrometer, Bruker Avance Neo (Bruker GmbH, Germany), at 500 MHz and a magic angle a spin rate of 12 kHz. A standard CP/MAS pulse sequence was employed, with a cross-polarization (CP) contact time of 2000 μs and a recycle delay of 2 s. A total of 42,200 scans were collected to obtain the final spectra.

Mass spectrometry. The molecular mass of samples was analyzed with Matrix-assisted laser desorption/ionization time-of-flight mass spectrometry (MALDI-TOF-MS) using a MALDI-TOF Bruker Autoflex Max LRF.

Zeta potential. A Zeta potential analyzer, ZetaPALS (from Brookhaven Instruments, USA) was used for measuring aqueous zeta potential of PCM membranes and PTFE substrates. The membranes and substrates were cut to a size of 2 cm×1 cm and fixed on sample holders using a double-side adhesive silicon tape and then the sample was plugged into a cell with a gap height of 100 microns, which was fixed onto an Electrokinetic analyzer recirculated with 1.0 mM NaCl solution at 400 mbar pressure for 200 seconds. Two measurements were taken, and the averaged data for each membrane at the target pressure of 200 mbar were considered. The surface zeta potential (z; mV) was then estimated using the Helmholtz-Smoluchowski equation.

Atomic Force Microscopy. The AFM analysis was done using CSI NanoObserver 2 AFM. The membrane samples were mounted onto the sample holder using adhesive tape and was positioned on the AFM scanner equipped with an optical head for cantilever deflection detection. A silicon nitride cantilever operated in oscillating mode at a resonant frequency of approximately 150 kHz was used for all measurements. AFM images were acquired with a scan area of 2 μm×2 μm using non-contact oscillating mode, and the RMS roughness parameter was analyzed utilizing Gwyddion 2.64 software (Czech Metrology Institute, Czech Republic). The analysis was done at room temperature.

Contact angle. The deionized water and methanol were used as the wetting liquid at room temperature.

The surface area and pore characteristics of the PCM and COF samples were measured using a Micromeritics ASAP 2020 surface area and porosimetry analyzer (Micromeritics, USA) at 77 K under liquid nitrogen. Surface area was determined by the Brunauer-Emmett-Teller (BET) method, and pore-size distribution and pore volume were obtained using the Barrett-Joyner-Halenda (BJH) method.

### Examples: Synthesis of Porous Cage Membranes

A porous composite membrane (PCM) according to the present embodiment was prepared through an imine condensation reaction on a polymeric PTFE support as follows. First, an aldehyde monomer solution (Solution A) was prepared by dissolving 30 mg of 1,3,5-triformylbenzene in 30 mL of methanol, while an amine monomer solution (Solution B) was prepared by dissolving 30 mg of tris(4-aminophenyl)amine in 30 mL of methanol. A PTFE support having an area of 38.5 cm² was placed in a 500 mL beaker. Solution A was added slowly onto the PTFE support, followed by slow addition of Solution B to the beaker without disturbing the reaction medium. The reaction vessel was covered and the reaction proceeded at room temperature. After approximately 6 hours, a reddish layer formed over the PTFE support. The reaction was allowed to continue for 2 days at which time the membrane was collected and washed thoroughly with dichloromethane, N,N-dimethylformamide (DMF), chloroform (CHCl₃), and methanol. The washed membrane was then dried in an oven at 70° C. to produce a porous cage membrane (PCM).

For PCM 2-3 the procedure of PCM was repeated, with the exception of the monomer concentrations as set forth in table 1:

TABLE 1
PCM Preparation Parameters and Concentrations

| | TFB | TAPA | | Support | |
|---|---|---|---|---|---|
| | Monomer | Monomer | Methanol | Area | Membrane |
| Example | (mg) | (mg) | (mL) | (cm²) | thickness(μm) |
| PCM | 30 | 30 | 30 | 38.5 | 145 |
| PCM2 | 50 | 50 | 30 | 38.5 | 179.2 |
| PCM 3 | 75 | 75 | 30 | 38.5 | 192 |

The Membrane thickness of PCM, PCM2, PCM3 as noted in Table 1 is their post-preparation thickness, with the layer of POC polymer applied.

### Comparative Examples: Synthesis of Covalent Organic Framework

An identical process and the same aldehyde and amine monomers were used in the comparative examples to make the covalent organic framework membrane,—except that the solvents used to make the monomer solutions were different. Specifically, an aldehyde monomer solution (Solution A) was prepared by dissolving 30 mg of 1,3,5-triformylbenzene in 30 mL of N,N-dimethylformamide (DMF) while an amine monomer solution (Solution B) was prepared by dissolving 30 mg of tris(4-aminophenyl)amine in 30 mL of DMF.

A PTFE membrane support having an area of 38.5 cm² was placed in a 500 mL beaker. Solution A was added slowly onto the PTFE support membrane, and after 5 minutes, Solution B was added slowly to the beaker without disturbing the reaction medium.

The reaction vessel was covered and the reaction was conducted at room temperature for 4 days. After 4 days, a yellow membrane formed on the polymer support was collected and washed thoroughly with dichloromethane, methanol, DMF, and chloroform (CHCl₃). The washed membrane was then dried in an oven at 70° C. to produce a COF membrane material.

For comparison a series of COF samples were prepared. The above preparation procedure was repeated, except for the monomer concentrations as set forth in table 2:

TABLE 2
COF Membrane Preparation Parameters and Concentrations

| | TFB | TAPA | | |
|---|---|---|---|---|
| | Monomer | Monomer | DMF | Experimental |
| Example No. | (mg) | (mg) | (mL) | Condition |
| COF | 30 | 30 | 30 | No Stirring |
| COF2 | 30 | 30 | 30 | Stirring at Room |
| | | | | Temp |
| COF3 | 30 | 30 | 30 | stirring at 50° C. |

From a visual inspection it could be seen that the PCM type and COF type membranes displayed significant color differences—the PCM was reddish while the COF membranes were yellow. Also the PCM materials which had a smooth and unbroken surface, the COF membrane material was considerably cracked.

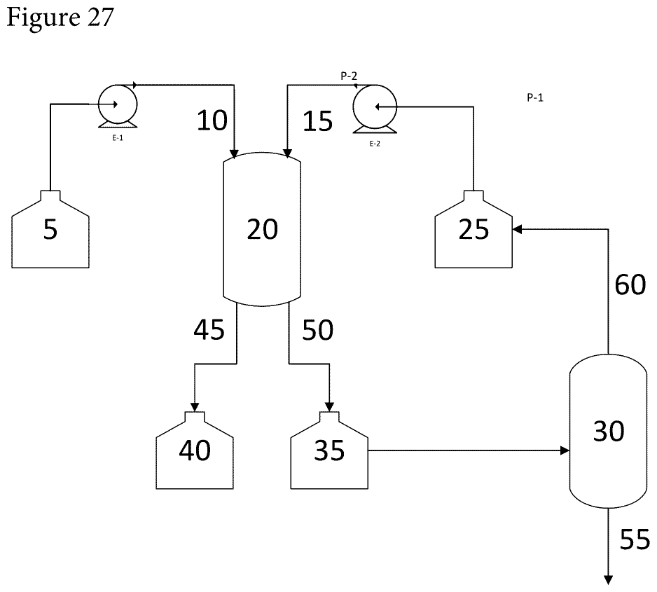

Beyond this visual inspection and to confirm the structure of PCM, an array of analytical, surface characterization techniques, and performance test were performed and compared with the results of the same tests performed on COF. The results of these tests are shown in FIGS. 1-27.

FIG. 1(a) shows FTIR spectra for both PCM and COF membranes confirming the formation of imine bonds revealed by their characteristic absorption peak at 1620 cm⁻¹, which is attributed to the C═N (imine) bond vibration. The formation of this imine bond provides chemical confirmation of the existence of imine linkage bonds that is essential to covalent framework or Porous Organic Cage chemistry. Interestingly it can also be seen in the FIG. 1(b), that the FTIR spectra of PCM and COF are similar, which indicates that both have the same kinds of functional groups and chemical linking bonds in their structure.

Additional confirmation of the completeness of the imine linkage reactions is the complete consumption of the amine monomers as evidenced by disappearance of, for example, the amine N—H stretching signals at 3404 cm-1 and 3332 cm-1 from the FTIR spectra of the PCM as shown in FIG. 1(b).

Evidence confirming that these imine bonds have not only been chemically made from the starting monomers but have also been physically formed into ordered cage or covalent frameworks of short- or long-range order can be provided by PXRD. The PXRD pattern of monomers was summarized in FIG. 2(a) and the transformations to the patterns shown in FIG. 2(b) confirm the formation of PCM and COF. As observed from the XRD pattern shown in FIG. 2(b), PCM shows peaks at 7°, 11.8°, 18.1°, and 22.1°, corresponding to the [100], [110], [210], and [001] planes, respectively. Meanwhile, the COF shows slightly lower peak values of 6.8°, 11.3°, and 22.7°. These peaks for COF are similar to what has been reported in the literature and confirms that COF has an interlayer structure as a covalent organic framework. Based on their measured angles for the [100] crystal plane, PCM's pore size is 12.6 Å, whereas COF is 13 Å. This is identical to the literature reports that COF reacting from 3 moles each of aldehyde monomer and amine monomer has a pore size of 13 Å.

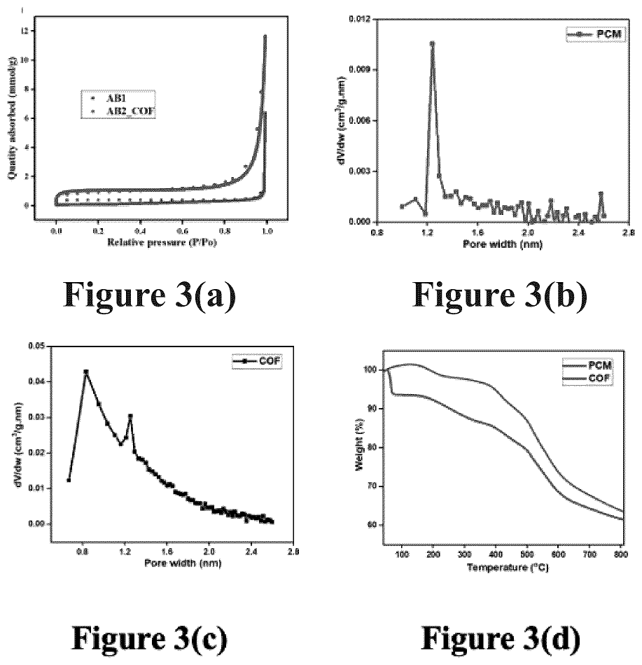

The morphology of the PCM and COF materials can be illustrated by measurements of their surface area and pore volume in N₂ sorption isotherms at 77 K (FIG. 3(a)). They show type I sorption behavior with BET surface areas of 6.7 m²/g and 90 m²/g and total pore volumes of 0.22 cm³/g, and 0.40 cm³/g for PCM, and COF, respectively. The pore size distribution curves for PCM and COF indicated that pore size of 1.23 nm for PCM, and COF has 0.83 nm and 1.26 nm (FIGS. 3(b) and (c)). The smaller pore size of PCM and lower surface area and pore volume compared to COF suggest that PCM has a different structural construction, most probably a cage-like structure, compared to COF.

The thermal stability of these materials was investigated via thermogravimetric analysis (TGA) in an inert N₂ atmosphere at a heating rate of 10° C./min from room temperature to 800° C. (FIG. 3(d)). Comparison of the two TGA curves shows that the thermal degradation of PCM and COF occurs in two main steps, suggesting similar bond linkages and functional groups, consistent with the FTIR analysis (FIG. 1 and discussion of, above). For COF, the first degradation event below 80° C. is attributed to the elimination of adsorbed water molecules and residual solvent. PCM shows significant decomposition beginning at approximately 200° C. with a mass loss of 37 wt %, attributed to collapse of the molecular structure, followed by a sharper second step beginning around 450° C. In contrast, COF shows initial degradation starting near 80° C. and framework collapse with a mass loss of 30 wt % above 200° C., indicating higher thermal stability than PCM due to its more ordered interlayer structure and extended framework connectivity.

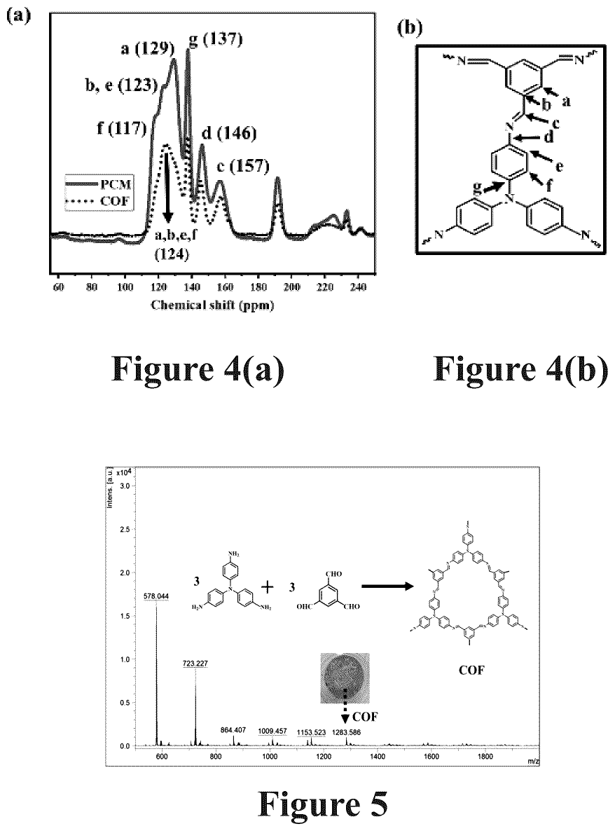

To verify the atomic-level structure of the PCM and COF frameworks, solid-state ¹³C-cross-polarization magic angle spinning nuclear magnetic resonance (13C-CP MAS NMR) spectroscopy was performed. As shown in FIGS. 4(a) and 4(b), strong resonance peaks at 117-129 ppm correspond to aromatic carbons (C═C) in the benzene rings, while the peak at 137 ppm corresponds to aromatic carbon atoms bonded to nitrogen. Notably, peaks at 146 ppm and 157 ppm correspond to carbon atoms in C═N (imine) and C—N bonds, respectively, present in both PCM and COF structures. The ¹³C CP-MAS NMR spectra exhibit similar patterns in the 137-157 ppm region for both materials. However, the 117-129 ppm region for COF shows peak splitting, confirming the formation of a more ordered framework structure compared to PCM. The spectral similarity between the two compounds confirms formation of similar chemical environments around the carbon atoms. These ¹³C CP-MAS NMR results are consistent with previously reported COF spectra in the literature. Collectively, the FTIR, ¹³C NMR, and TGA data indicate that while PCM and COF share the same imine linkages, COF exhibits more robust interlayer packing and stronger π-π stacking interactions, resulting in its higher thermal stability.

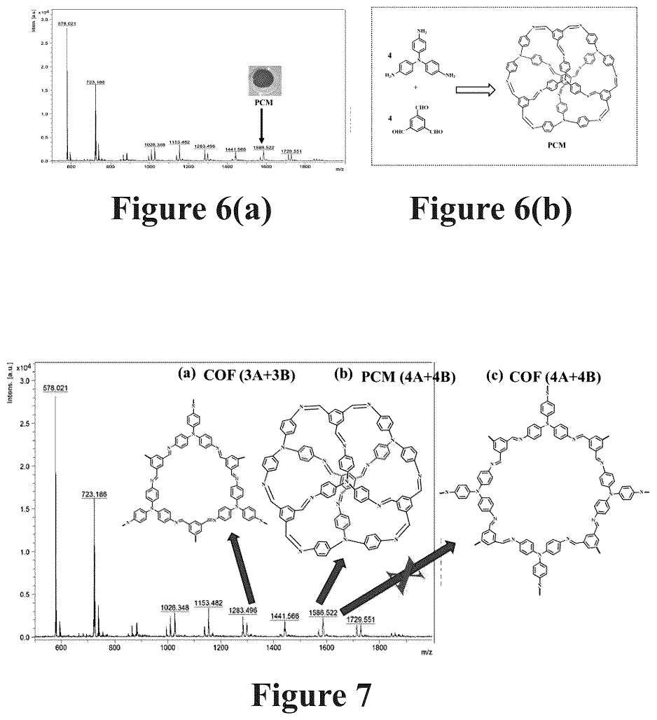

Matrix-assisted laser desorption/ionization time-of-flight mass spectrometry (MALDI-TOF-MS) was employed to further confirm structural differences between PCM and COF. The MALDI-TOF-MS spectrum of COF showed a peak at m/z 1283, corresponding to a structure formed by condensation of three amine monomers with three aldehyde monomers (FIG. 5). In contrast, the MALDI-TOF-MS spectrum of PCM exhibited a higher molecular mass at m/z 1583 ((FIG. 6(a)), indicating a different structural composition (proposed in FIG. 6(b)).

To elucidate the structure of PCM, theoretical molecular weights were calculated: condensation of four amine and four aldehyde monomers would yield m/z˜1594, while five of each monomer would yield m/z˜1992. MALDI-FT-ICR-MS analysis of PCM gave a molecular mass of m/z 1586, confirming condensation of four amine and four aldehyde monomers. Based on this molecular mass, two possible structures were considered: (1) a COF-like extended framework (structure (c) in FIG. 7) or (2) a discrete cage structure (structures (a) and (b) in FIG. 7.

If PCM had a COF-like structure with 4+4 monomers (FIG. 7(c)), it would be expected to have a larger pore size than COF. However, powder X-ray diffraction (PXRD) analysis showed that PCM has a smaller pore size (12.6 Å) compared to COF (13 Å). Additionally, TGA analysis confirmed lower thermal stability for PCM compared to COF, and BET analysis revealed that the pore volume of PCM is approximately 50% less than that of COF. These complementary analytical results support the proposed cage structure for PCM shown in FIG. 7(b).

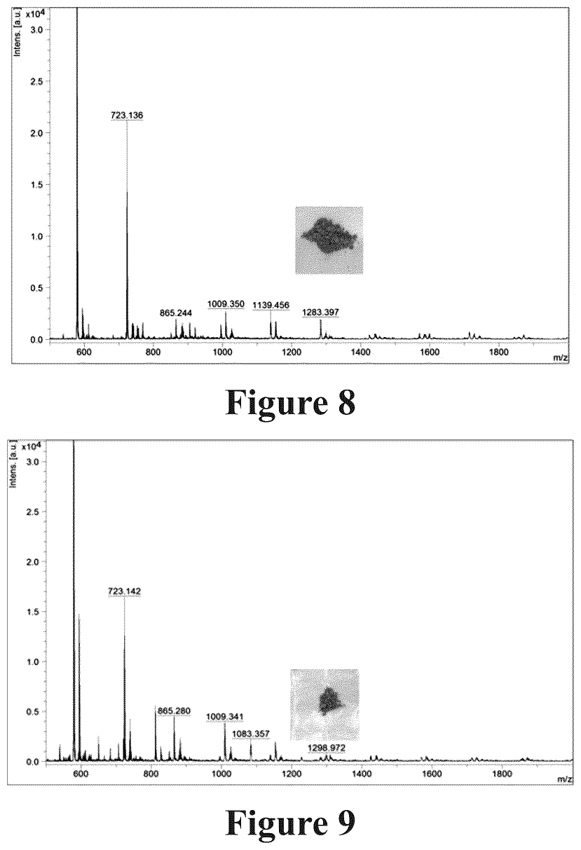

To investigate whether solvent choice determines PCM versus COF formation, additional reactions were conducted in DMF under different conditions: stirring at room temperature (COF2) and stirring at 50° C. (COF3). The MALDI-TOF-MS spectra of both COF2 and COF3 showed peaks at m/z 1283, identical to COF, demonstrating that the DMF promotes covalent organic framework formation regardless of temperature (see the MALDI-TOF-MS spectrums of COF2 and 3 in FIGS. 8 and 9). This solvent-dependent structural outcome can be attributed to the difference in polarity: methanol is a polar protic solvent with a lower polarity index (5.1) compared to polar aprotic DMF (6.4), thus favoring cage formation in methanol and framework formation in DMF.

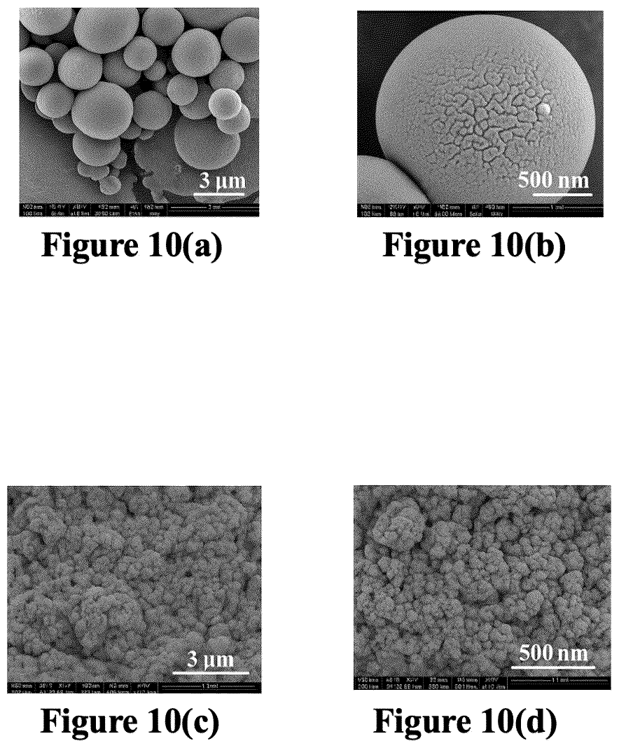

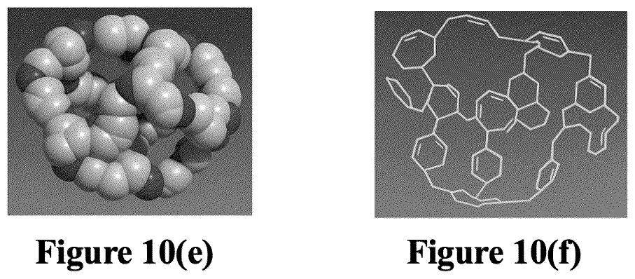

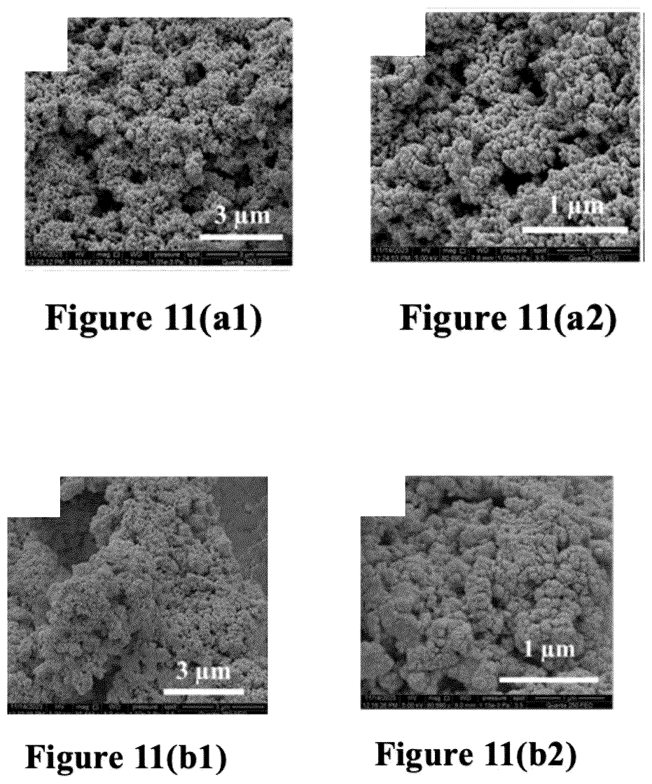

Scanning electron microscopy (SEM) further revealed distinct morphological differences between the PCM and the COF. The PCM exhibited larger spherical particles (FIGS. 10(a) and (b)), while COF consisted of agglomerated smaller spherical particles (FIGS. 10(c) and (d)). COF2 and COF3 displayed morphology similar to COF (FIG. 11), confirming framework formation in DMF under varying conditions. Based on these comprehensive characterization results, PCM is confirmed to exist as a discrete Porous Organic Cage structure, with proposed 3D structures shown in FIGS. 10(e) and 10(f).

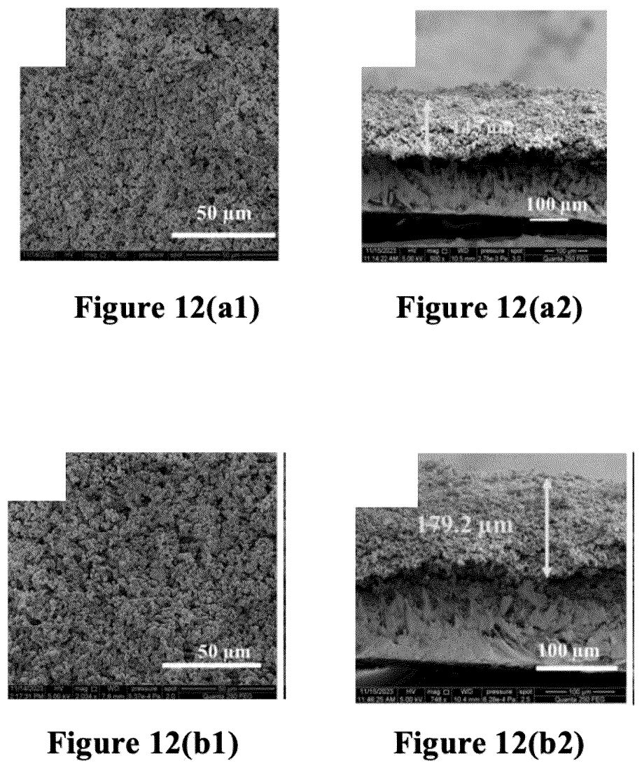

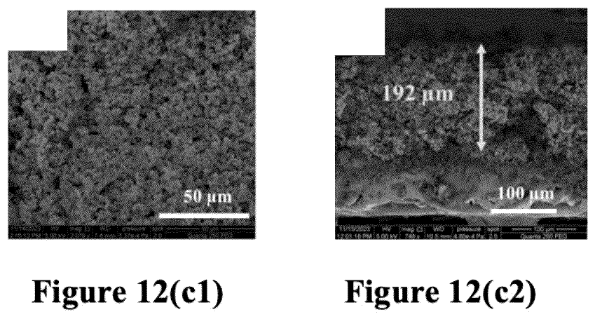

SEM analysis of the PCM membrane surface and cross-section revealed well-ordered packing of PCM on the PTFE support with no observable pinholes or cracks (FIG. 12(a1)). Cross-sectional imaging showed the PCM membrane had a thickness of 145 μm (FIG. 12(a2)). Membranes prepared with higher monomer concentrations (PCM2 and PCM3) exhibited increased thicknesses of 179.2 μm and 192 μm, respectively, corresponding to monomer concentrations of 50 mg and 75 mg per 30 mL of methanol (FIGS. 12(b1) and 12(b2) for PCM2; FIGS. 12(c1) and 12(c2) for PCM3).

As discussed above an important aspect of the PCM embodiments for their application to water treatment and heavy metal recovery applications is solvent-responsive behavior. The solvent-responsive pore switching property of the PCM membrane was confirmed through two complementary experiments: organic dye removal and heavy metal ion transport, both evaluated in water versus methanol to demonstrate reversible, solvent-controlled permeation.

For organic dye removal, the PCM membrane exhibited dramatically different performance depending on solvent. As shown in FIG. 14(a), the membrane achieved 94.5% removal of rhodamine B (Rh B) in pure water compared to only 19.9% removal in pure methanol for a feed concentration of 25 mg/L. FIG. 14(b) shows the UV-Vis absorption spectra of Rh B permeate in various water: methanol solvent mixtures at 25 mg/L Rh B concentration, demonstrating the gradual transition in permeation behavior. FIG. 14(c) presents digital photographs of the Rh B permeate solutions in different solvent mixtures, visually confirming the solvent-dependent rejection.

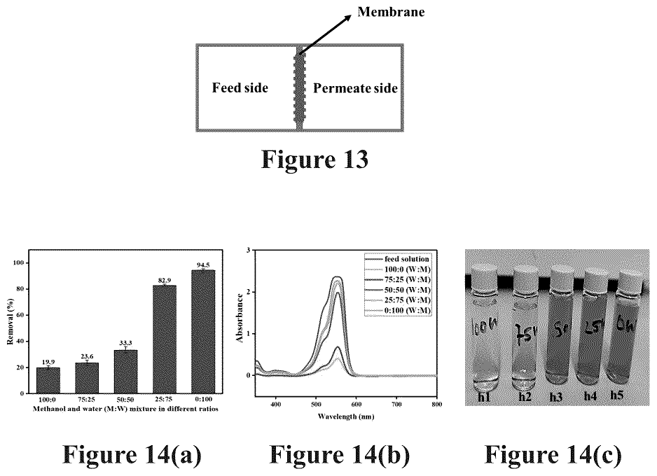

Heavy metal ion transport experiments provided complementary evidence of solvent-responsive behavior using Ni²⁺ and Zn²⁺ ions. These experiments were conducted in a custom-designed glass diffusion cell (FIG. 13), with the PCM membrane (area 0.785 cm²) sealed at the joint between the two cell compartments. FIG. 14 shows heavy metal ion permeation rates and concentrations in methanol and water using PCM membranes. As shown in FIGS. 15(a), (b), and (c), Ni²⁺ and Zn²⁺ ions did not permeate through the PCM membrane in water, whereas in methanol they exhibited high permeation rates. This inverse relationship, where the membrane blocks by size sieving ions in water but allows transport in methanol, enables a complete capture-and-recovery cycle: metal ions are selectively retained from aqueous solutions and then efficiently recovered by switching to methanol. Similar ion permeation behavior in water and methanol was observed with PCM2 and PCM3 for both Ni²⁺ and Zn²⁺ ions (FIG. 16), confirming the consistency and reproducibility of the solvent-responsive property across different membrane thicknesses.

The significantly different rejection of Rh B dye and heavy metal ions in water versus methanol suggests dynamic structural changes in the PCM cage, resulting in solvent-responsive pore size modifications as described above in detail on the proposed mechanisms for the POC and PCM behavior. To confirm this mechanism, two experiments were conducted: (1) evaluation of pore aperture reversibility during Rh B filtration by varying the water: methanol ratio, and (2) extraction of Ni²⁺ and Zn²⁺ ions from PCM membranes in methanol following ion permeation experiments in water.

In the first experiment, Rh B rejection increased from 19.9% to 94.5% as the water content increased from 0% to 100% in the solvent mixture (FIG. 16(a)). At 50% methanol:50% water, the rejection rate was 33.3%, indicating that methanol-induced cage expansion remains predominant even at this intermediate composition. At 75% water:25% methanol, rejection increased substantially to 82.9%, demonstrating self-regulating cage contraction in response to increasing water content. Above 75% water content, water becomes the dominant external stimulus, leading to a contracted PCM structure with reduced pore size and high Rh B rejection. FIG. 14(b) displays the UV-Vis absorbance spectra of permeate Rh B solutions at different water:methanol ratios, while FIG. 14(c) presents digital photographs of the permeate solutions at varying solvent compositions.

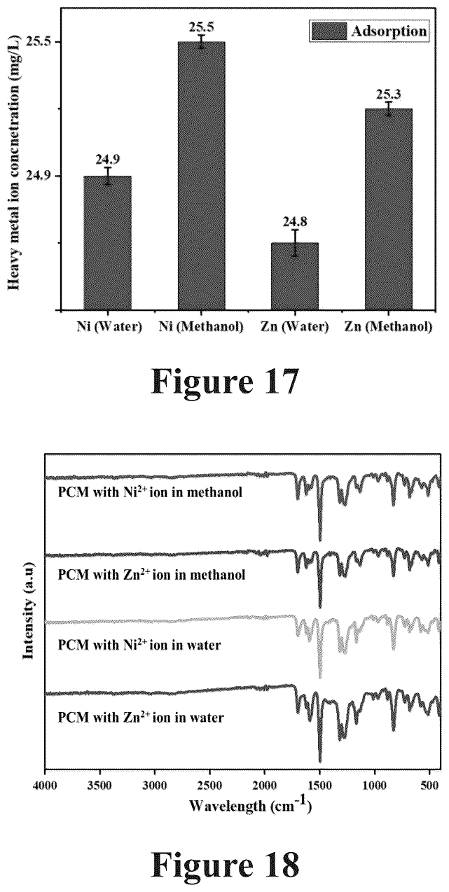

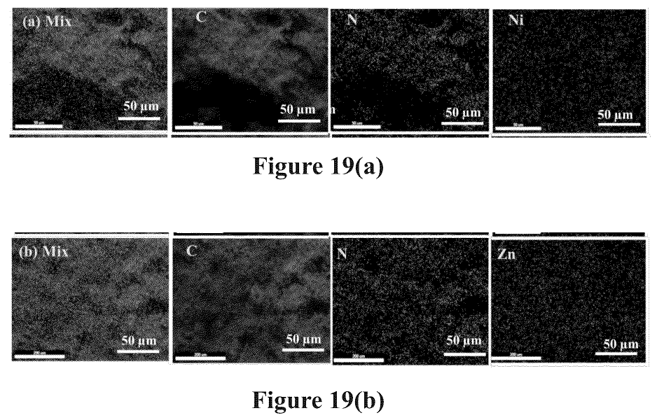

To confirm that heavy metal ions are physically trapped within the contracted PCM structure rather than adsorbed, several analyses were performed. PCM showed no adsorption capacity for heavy metals in control experiments (FIG. 17). FTIR spectra of PCM samples after 4 days of ion permeation experiments showed no significant changes in vibrational bands, indicating the absence of chemical interactions between heavy metals and the PCM framework (FIG. 18). However, energy-dispersive X-ray (EDX) mapping of PCM after 4 days of ion permeation confirmed the presence of Ni²⁺ and Zn²⁺ ions within PCM (FIG. 19). These results demonstrate that metal ions are physically entrapped inside the contracted PCM cage structure in aqueous media rather than being adsorbed on the surface.

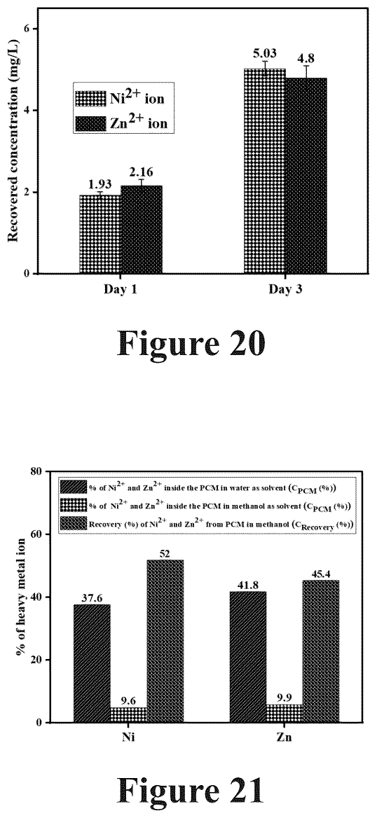

In the second experiment, heavy metal extraction from PCM membranes was evaluated by immersing ion-loaded PCM membranes in methanol for 2 days with shaking at 100 rpm and monitoring the metal ion concentration in methanol over time. FIG. 20 shows that the amount of Ni²⁺ ions released from the PCM membranes increased with time, reaching 5.03 mg/L after 2 days. Similarly, Zn²⁺ ion concentration reached 4.80 mg/L in methanol after 2 days (FIG. 20). FIG. 21 quantifies the percentage of Ni²⁺ and Zn²⁺ ions retained inside the PCM after ion permeation in water and the subsequent recovery efficiency in methanol. During the ion permeation test in water, 37.6% and 41.8% of the initial Ni²⁺ and Zn²⁺ ions, respectively, were retained within the PCM structure (C_{PCM} (%)). The recovery efficiency (C_{Recovery}) of these trapped ions using methanol was 52% for Ni²⁺ and 45.4% for Zn²⁺.

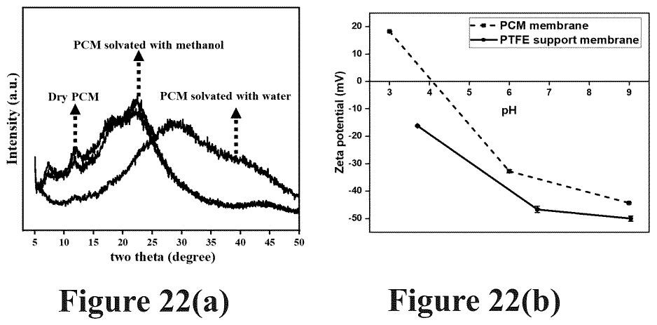

To investigate “solvent responsive” pore size changes in PCMs upon exposure to different solvents as described above, PCM membranes were solvated separately with water and methanol, and analyzed by powder X-ray diffraction (PXRD). As shown in FIG. 22(a), the PXRD pattern of PCM solvated in methanol closely resembles that of dry PCM. In contrast, the PXRD peaks of water-solvated PCM shifted significantly: from 7.0° to 11.8°, from 12.1° to 14.3°, and from 22.1° to 28.9°. These shifts indicate that Example 1 contracts to a pore size of 7.4 Å in water compared to 12.6 Å in methanol.

The mechanism underlying this solvent-responsive behavior involves host-guest interactions between the flexible cage structure and the surrounding solvent. In methanol, strong host-guest interactions stabilize the expanded cage structure, eliminating structural undulations and providing unobstructed passage for permeants. In water, the flexible bonds in the organic linkers contract, leading to changes in bond angles and node distances that reduce the pore size to 7.4 Å.

This solvent-induced pore size modulation explains the observed selectivity for both dye and metal ions. For Rhodamine B (molecular diameter 12.5 Å), the contracted PCM structure in water (pore size 7.4 Å) achieves high rejection (94.5%) through a molecular sieving mechanism, while the expanded structure in methanol (pore size 12.6 Å) allows dye passage, resulting in low rejection (19.9%). For heavy metal ions, the hydrated diameters of Zn²⁺ (8.6 Å) and Ni²⁺ (8.08 Å) exceed the contracted pore size in water (7.4 Å), preventing permeation. However, the solvated diameters of these ions in methanol (˜10 Å) are smaller than the expanded pore size (12.6 Å), enabling transport through the membrane.

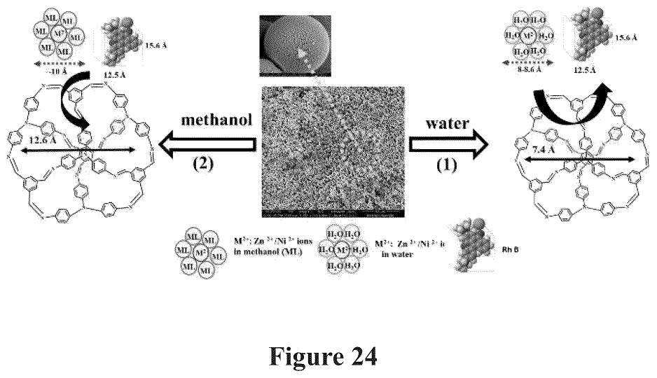

In addition to size exclusion, electrostatic interactions contribute to selectivity in water. As shown in FIG. 22(b), the PCM membranes exhibit a negative surface charge at natural pH in water, enhancing rejection of cationic Rhodamine B through electrostatic repulsion. This negative surface charge also restricts heavy metal ion transport across the membrane in water through electrostatic interactions (FIG. 24, arrow (1)). In methanol, electrostatic interactions become less significant due to the expanded pore structure (12.6 Å) and lower dielectric constant of the solvent, allowing both Rh B and heavy metal ions to pass through the membrane readily (FIG. 24 arrow (2)).

The heavy metal recovery mechanism exploits this reversible structural change. When ion-loaded PCM membranes from aqueous permeation experiments are immersed in methanol, the solvent stimulus induces cage expansion to 12.6 Å, releasing the trapped metal ions into the methanol phase.

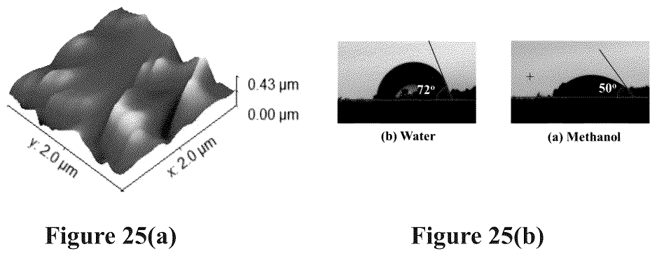

Atomic force microscopy (“AFM”) analysis of the PCM membrane revealed a root mean square (RMS) roughness of 61.79±3.5 nm (FIG. 25(a)). This high surface roughness increases the contact surface area between the membrane and contaminants, contributing to enhanced rejection performance in water. Additionally, contact angle measurements showed that PCM exhibits greater wettability in methanol (contact angle 50°) compared to water (contact angle 72°), FIG. 25(b), which facilitates higher permeation rates in methanol.

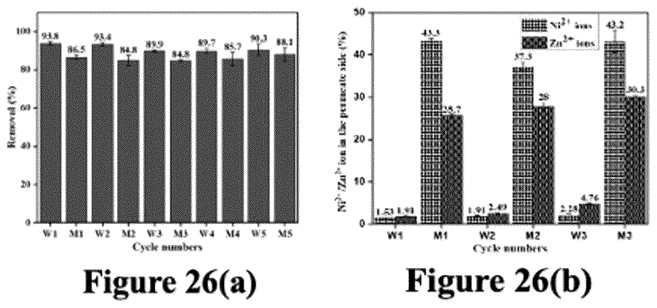

The recycling performance of the PCM membrane for Rhodamine B removal in water and methanol was evaluated over five consecutive cycles (FIG. 26(a)). After five cycles, the PCM membrane retained its ability to remove Rh B from aqueous solution with high efficiency (89-93%). During each regeneration phase, the membrane was flushed with methanol to remove accumulated Rh B from the membrane surface. The concentration of Rh B in the methanol permeate indicated that 86.5-88.2% of the captured dye was successfully removed from the PCM membrane during each methanol wash cycle. These results demonstrate that the solvent-responsive pore switching property of the PCM membrane remained functional after five complete capture-regeneration cycles.

Long-term stability and recyclability of the PCM membrane were further evaluated for heavy metal ion transport using Ni²⁺ and Zn²⁺ (25 mg/L initial concentration) over three complete cycles alternating between water and methanol (FIG. 26(b)). Each cycle consisted of a two-day aqueous phase followed by a two-day methanol phase using the same membrane without replacement. During the aqueous phase, 15 mL of Ni²⁺ or Zn²⁺ solution in water was placed in the feed side of the diffusion cell, with 15 mL of deionized water in the permeate side. After two days, both solutions were replaced with 15 mL of metal ion solution in methanol (feed side) and 15 mL of pure methanol (permeate side) for an additional two days.

The PCM membrane demonstrated consistent ion retention in water across all three cycles, with only 1.5-2.2% of Ni²⁺ ions and 1.9-4.7% of Zn²⁺ ions permeating through the membrane during each aqueous phase. In contrast, during the methanol phase, 43% of Ni²⁺ ions and 30% of Zn²⁺ ions permeated through the membrane over the three cumulative cycles. The stable performance across multiple cycles confirms the long-term durability and reversible solvent-responsive behavior of the PCM membrane, demonstrating its suitability for repeated heavy metal capture and recovery operations.

While the embodiment has been described with reference to exemplary embodiments, it will be understood by those skilled in the art that various changes may be made and equivalents may be substituted for elements thereof without departing from the scope of the embodiment. In addition, many modifications may be made to adapt a particular situation or material to the teachings of the embodiment without departing from the essential scope thereof. Therefore, it is intended that the embodiment not be limited to the embodiments disclosed, but that the embodiment will include all embodiments falling within the scope of the appended claims.

1. A method for preparing a Porous Cage Membrane, the method comprising: forming a Porous Organic Cage polymer by reacting 1,3,5-triformylbenzene with tris(4-aminophenyl)amine in a solvent comprising methanol; and depositing the Porous Organic Cage polymer onto a porous support comprising polytetrafluoroethylene to form the Porous Cage Membrane.

2. The method according to claim 1, wherein the forming step further comprises: dissolving the 1,3,5-triformylbenzene in a first portion of the solvent to form a first solution; dissolving the tris(4-aminophenyl)amine in a second portion of the solvent to form a second solution; and combining the first solution and the second solution to initiate a condensation reaction between the 1,3,5-triformylbenzene and the tris(4-aminophenyl)amine.

3. The method according to claim 2, wherein the 1,3,5-triformylbenzene is present in the first solution at a concentration of about 1 mM to about 100 mM.

4. The method according to claim 2, wherein the tris(4-aminophenyl)amine is present in the second solution at a concentration of about 1 mM to about 100 mM.

5. The method according to claim 1, wherein the 1,3,5-triformylbenzene and the tris(4-aminophenyl)amine are present in a molar ratio of about 2:1 to about 5:2.

6. The Porous Cage Membrane according to claim 1, wherein the Porous Cage Membrane has a thickness of about 0.125 mm to about 0.200 mm.

7. The method according to claim 1, wherein the porous support has a pore size of 0.1-10 μm.

8. The method according to claim 1, wherein the Porous Cage Membrane has a pore size of 10-15 Å when solvated in methanol.

9. A membrane, comprising: a porous support comprising polytetrafluoroethylene (PTFE); and a Porous Organic Cage polymer layer on the porous support, wherein the Porous Organic Cage polymer layer comprises imine linkages formed from condensation of 1,3,5-triformylbenzene and tris(4-aminophenyl)amine.

10. A membrane according to claim 9, wherein the Porous Organic Cage polymer layer has a molecular weight of 1570-1600 Daltons as measured by MALDI-TOF-MS.

11. A membrane according to claim 9, wherein the porous support has a pore size of 0.1-10 μm.

12. A membrane according to claim 9, wherein the Porous Organic Cage polymer layer has a pore size of 10-15 Å when solvated in methanol.

13. The membrane according to claim 9, wherein the Porous Organic Cage polymer layer has a thickness of 125 to 200 microns.

14. A water treatment system comprising the membrane of claim 9.

15. A method of removing heavy metal ions from an aqueous solution, comprising contacting the aqueous solution with the membrane of claim 9 to form retained metal ions; and recovering the retained metal ions by contacting the membrane with methanol.

16. The membrane of claim 9, wherein membrane exhibits solvent-responsive pore size changes, having a first pore size when in contact with water and a second pore size when in contact with methanol, wherein the second pore size is larger than the first pore size.

17. The membrane of claim 9, wherein the Porous Organic Cage polymer layer has a pore size of 6-9 Å when in contact with water.

18. The membrane of claim 9, wherein the Porous Organic Cage polymer layer has a pore size of 11-14 Å when in contact with methanol.

19. A method for separating heavy metals from an aqueous solution comprising: (a) passing the aqueous solution through a membrane to capture heavy metal retentate on the membrane and form a treated aqueous solution; (b) regenerating the membrane by flushing a volatile organic solvent through the membrane to release the heavy metal retentate from the membrane to form a metal-rich volatile organic solvent; wherein the membrane comprises: a porous support comprising polytetrafluoroethylene (PTFE); and a Porous Organic Cage polymer layer on the porous support, wherein the Porous Organic Cage polymer layer comprises imine linkages formed from condensation of 1,3,5-triformylbenzene and tris(4-aminophenyl)amine.

20. The method of claim 19 further comprising: (c) separating, in a stripping column, the metal-rich volatile organic solvent into a recovered heavy metals bottom stream and a purified organic solvent overhead; and (d) recycling the purified organic solvent overhead to the regeneration step (b).
